(19) United States
(12) Patent Application Publication
(10) Pub. No.: US 2003/0113598 A1
(43) Pub. Date: Jun. 19, 2003

(54) Method and apparatus for removing sulfur from a hydrocarbon fuel

(75) Inventors: Benny W. Chow, Coquitlam (CA); Leonard McNeilly, San Diego, CA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Ballard Power Systems Inc., Burnaby (CA)

(21) Appl. No.: 10/037,486

(22) Filed: Dec. 19, 2001

(51) Int. Cl. H01M 8/06

(52) U.S. Cl. 429/17; 429/19; 95/135; 96/121

(57) ABSTRACT

A desulfurization unit is provided. In one embodiment, the present desulfurization unit comprises: a first adsorbent bed having an inlet for receiving a hydrocarbon fuel stream and comprising an adsorbent selected from the group consisting of metal oxides and zeolites; a downstream nickel adsorbent bed; and a downstream guard bed comprising an adsorbent selected from the group consisting of copper-zinc adsorbents, activated alumina, activated carbon, and zeolites. Processes for desulfurizing hydrocarbon fuel streams employing the present desulfurization unit are provided. Fuel cell electric power generation systems employing the present desulfurization unit are also provided.

### FIELD OF THE INVENTION

The present invention relates to shell and tube reactors for fuel processing systems, particularly shell and tube reactors having fixed tubes and comprising a shift catalyst bed.

### BACKGROUND OF THE INVENTION

Fuel cell electric power generation systems require a source of hydrogen in order to generate electrical power. Fuel processing systems are employed to produce hydrogen when a hydrocarbon fuel is employed. Typically, the hydrocarbon fuel is directed to a reformer where it is catalytically reacted to form a reformate gas comprising hydrogen.

Many hydrocarbon fuels contain organic sulfur compounds. Pipeline natural gas, for example, contains added odorants such as mercaptans and thiophenes, as well as trace amounts of other organic sulfur compounds such as sulfides, disulfides and COS. These sulfur-containing compounds are typically removed from the fuel before reforming, since many catalysts used in fuel processing components, such as reformers, shift reactors and selective oxidizers, are easily poisoned by sulfur.

The fuel may be subjected to a hydrodesulfurization (HDS) process where the organic sulfur compounds are converted into inorganic compounds (primarily H₂S) over a hydrodesulfurization catalyst in the presence of hydrogen, which are then removed in a metal oxide bed. U.S. Pat. Nos. 5,302,470 and 5,685,890, for example, describe a conventional HDS process employing a hydrodesulfurization catalyst bed, a ZnO adsorption bed, and a copper/zinc desulfurization agent, also known as a sulfur guard. The process is recommended for raw fuels containing large amounts of sulfur, including organic compounds that are difficult to decompose, such as thiophenes and dimethyl sulfide.

Conventional HDS processes require hydrogen in the fuel, which is typically provided by recycling a portion of the hydrogen-rich reformate. Such systems undesirably increase the complexity of the fuel processing system, due to the equipment, piping and control systems required for the hydrogen recycle. In addition, such systems adversely impact the fuel conversion efficiency of the fuel processing system, as a portion of the reformed fuel must be recycled to the hydrodesulfurizer. In addition, where the hydrogen recycle employs reformate containing carbon monoxide, there is a risk of forming nickel carbonyl compounds in the HDS. These compounds are very toxic and can be lethal.

The '470 and '890 patents also describe desulfurizing a raw hydrocarbon fuel by directly subjecting it to a copper/zinc desulfurization bed. This approach eliminates the need for a hydrogen recycle. However, it is recommended only for raw fuels having relatively low sulfur compound contents (10 ppm or less). For desulfurizing fuels having higher sulfur compound content, this approach is not commercially practical. The copper/zinc bed is more costly in comparison to metal oxide beds, such as ZnO beds, and has a lower sulfur capacity, necessitating a larger bed or more frequent replacement.

The '470 and '890 patents also suggest desulfurizing a raw hydrocarbon fuel by first subjecting it to a primary desulfurization step to decrease the sulfur content to about 1-0.1 ppm in order to attain maximum effect of sulfur adsorption in the following high-grade desulfurization step in a copper/zinc bed. The primary desulfurization step may employ a ZnO desulfurization agent. This process is suggested for raw fuels having 10 ppm or more sulfur content, but less than 10 ppm of organic compounds that are difficult to decompose, such as thiophenes and dimethyl sulfide.

U.S. Pat. No. 5,882,614 describes a process for producing very low sulfur gas feeds for syngas and hydrocarbon synthesis processes. A hydrocarbon gas is contacted first with ZnO and then nickel metal. The process is reported to reduce the sulfur content of the gas to less than 10 vppb. The process, however, is typically used as a guard bed process. It is preferred to reduce the sulfur in the gas, in an amine scrubber, for example, to a level of less than 10 vppm before contacting it with the disclosed absorbents. The '614 patent does not indicate whether the described process is effective for raw fuels having higher sulfur contents and/or containing organic sulfur compounds such as thiophenes, disulfides or sulfides.

Japanese Unexamined Patent Application No. 6-17065, similarly describes a manufacturing method for city gas comprising the steps of performing primary desulfurization of raw material hydrocarbon using a zinc oxide absorbent material and afterward performing secondary desulfurization by means of a nickel absorbent material.

It would be desirable to have apparatus and processes for desulfurizing a hydrocarbon fuel that do not require a hydrogen recycle, as is the case in HDS processes. It would also be desirable to have apparatus and processes for desulfurizing a hydrocarbon fuel that are more cost effective than current processes, and that are capable of desulfurizing fuels having relatively high sulfur contents and/or concentrations of organic sulfur compounds.

### BRIEF SUMMARY OF THE INVENTION

A desulfurization unit is provided. In one embodiment, the present desulfurization unit comprises:

a first adsorbent bed having an inlet for receiving a hydrocarbon fuel stream and comprising an adsorbent selected from the group consisting of metal oxides and zeolites;

a downstream nickel adsorbent bed; and

a downstream guard bed comprising an adsorbent selected from the group consisting of copper-zinc adsorbents, activated alumina, activated carbon, and zeolites.

In another embodiment, the present desulfurization unit comprises:

a vessel having an inlet and outlet for receiving and discharging a hydrocarbon fuel stream;

a first bed disposed in an upstream portion of the vessel, the first bed comprising an adsorbent selected from the group consisting of metal oxides and zeolites;

a second bed disposed in a downstream portion of the vessel, the second bed comprising a nickel adsorbent; and

a guard bed disposed in a downstream portion of the vessel, the guard bed comprising an adsorbent selected from the group consisting of copper-zinc adsorbents, activated alumina, activated carbon, and zeolites.

In another embodiment, the present desulfurization unit comprises: an upstream first bed for adsorbing primary sulfur compounds from a hydrocarbon fuel stream; a downstream second bed for adsorbing secondary sulfur compounds from the fuel stream; and a downstream guard bed for adsorbing primary and secondary sulfur compounds from the fuel stream.

A process for reducing the sulfur content of a hydrocarbon fuel stream to ≦1 ppm is also provided. In one embodiment, the process comprises:

heating the fuel stream to a temperature greater than or equal to the thermal decomposition temperature of at least a portion of the primary sulfur compounds;

directing the fuel stream to a first bed comprising an adsorbent selected from the group consisting of metal oxides and zeolites;

directing the heated fuel stream to a downstream nickel adsorbent bed; and

directing the heated fuel stream to a downstream guard bed comprising an adsorbent selected from the group consisting of copper-zinc adsorbents, activated alumina, activated carbon, and zeolites.

In another embodiment, the process comprises:

directing the fuel stream to a first bed comprising an adsorbent selected from the group consisting of metal oxides and zeolites;

directing the fuel stream to a guard bed downstream of the first bed, the guard bed comprising an adsorbent selected from the group consisting of copper-zinc adsorbents, activated alumina, activated carbon, and zeolites; and

directing the fuel stream to a third bed downstream of the guard bed, the third bed comprising a nickel adsorbent.

A fuel cell electric power generation system is also provided. In one embodiment, the present power generation system comprises:

a fuel processing system for converting a hydrocarbon fuel stream to a reformate stream comprising hydrogen, and a fuel cell stack for receiving the reformate and connectable to an electrical load. The fuel processing system comprises a desulfurization unit comprising: an upstream metal oxide adsorbent bed; a downstream nickel metal adsorbent bed; and a downstream copper-zinc guard bed.

A method of operating the present fuel cell electric power generation system is also provided. In one embodiment, the method comprises:

directing the fuel stream to a first bed comprising an adsorbent selected from the group consisting of metal oxides and zeolites, and having a first minimum operating temperature;

directing the fuel stream to a downstream nickel adsorbent bed having a second minimum operating temperature;

directing the fuel stream to a downstream guard bed comprising an adsorbent selected from the group consisting of copper-zinc adsorbents, activated alumina, activated carbon, and zeolites, and having a third minimum operating temperature lower than the first and second minimum operating temperatures; and

heating the fuel stream to a process temperature that is higher than or equal to any of the first, second and third minimum operating temperatures.

### BRIEF DESCRIPTION OF THE SEVERAL VIEWS OF THE DRAWING(S)

FIG. 1 is a schematic representation of an embodiment of the present fuel cell electric power generation system and desulfurization unit.

### DETAILED DESCRIPTION OF PREFERRED EMBODIMENTS

The present apparatus and processes provide for the desulfurization of hydrocarbon fuels without the use of a hydrogen recycle. In one embodiment, the present desulfurization unit comprises a first bed for adsorbing primary sulfur compounds from a hydrocarbon fuel stream, a second bed for adsorbing secondary sulfur compounds from the fuel stream, and a guard bed for adsorbing primary and secondary sulfur compounds from the fuel stream.

As used herein and in the appended claims, hydrocarbon fuels include aliphatic and aromatic hydrocarbons and oxygenated derivatives thereof, in liquid or gaseous form. Non-limiting examples of hydrocarbon fuels are gasoline, diesel, natural gas, ethane, butane, light distillates, dimethyl ether, methanol, ethanol, propane, naphtha, and kerosene.

Primary sulfur compounds have a general structure of R—S or R—S—H (where R═H, C, CO, alkyl or aryl). Typical primary sulfur compounds include hydrogen sulfide, carbonyl sulfide and mercaptans (thiols and thiophenols). Secondary sulfur compounds have a general structure of R—S—R′ or R—S—S—R′ (where R, R′=alkyl or aryl). Examples of secondary sulfur compounds include sulfides (thioethers), disulfides and heterocyclic compounds such as thiophenes and tetrahydrothiophene.

Beds for adsorbing primary sulfur compounds preferentially adsorb such compounds, but may also adsorb secondary sulfur compounds to a lesser or greater extent. Similarly, beds for adsorbing secondary sulfur compounds adsorb them preferentially, but may also adsorb primary sulfur compounds.

The first bed may comprise an adsorbent selected from the group consisting of metal oxides and zeolites. Suitable metal oxides include oxides of zinc, iron, chromium, cobalt, copper, nickel, manganese, vanadium, bismuth, cadmium, lead and tin, and mixtures thereof. The metal oxides may be supported, such as the adsorbents described in U.S. Pat. No. 4,478,800, which is incorporated herein by reference in its entirety. The metal oxide may also form part of a support, such as the compositions having nickel oxide and a base material of zinc oxide or zinc titanate described in U.S. Pat. No. 5,094,996, which is incorporated herein by reference in its entirety. Suitable zeolites include naturally occurring zeolites such as mordenite, chabazite and erionite, and synthetic zeolites such as zeolites A, X, Y and L, for example. If desired, the zeolites may be ion exchanged with zinc, copper or iron cations, for example.

The second bed may comprise a nickel adsorbent. Nickel adsorbents include supported or unsupported nickel metal, alone or mixed with other metals, such as the copper-nickel alloy desulfurizing agent described in U.S. Pat. No. 5,800,798, which is incorporated herein by reference in its entirety.

The third bed may be a guard bed comprising an adsorbent selected from the group consisting of copper-zinc adsorbents, activated alumina, activated carbon, and zeolites. Copper-zinc adsorbents include copper-zinc and copper-zinc-aluminum desulfurization agents commercially available under the tradename PURASPEC from Synetix (Billingham, UK).

In another embodiment, the present desulfurization unit comprises two or more of the first, second and/or third adsorbent beds. For example, the duplicate beds can be arranged in series. At a maintenance interval, the spent first bed may be removed and replaced by the next in the series. A newly charged bed can then be inserted to complete the arrangement again. Alternatively, the duplicate beds can be connected in parallel and the unit configured to selectively direct the fuel stream through one of the beds. When one bed is spent, the fuel stream can be directed to the other bed and the spent bed can be replaced. If desired, the desulfurization unit can be configured to allow one of the duplicate beds to be disconnected during operation while the other(s) remain in service.

The adsorbent beds may be regenerable or disposable (i.e., not regenerable).

The adsorbent beds of the present desulfurization unit may be disposed in a single vessel, if desired. This approach may simplify the integration of the present desulfurization unit into a fuel processing system.

Alternatively, the adsorbent beds of the present desulfurization unit may be contained in separate vessels. Where the duty cycle of the beds varies, this approach may permit the replacement of spent beds without disturbing the others and may also facilitate the regeneration of regenerable adsorbent beds.

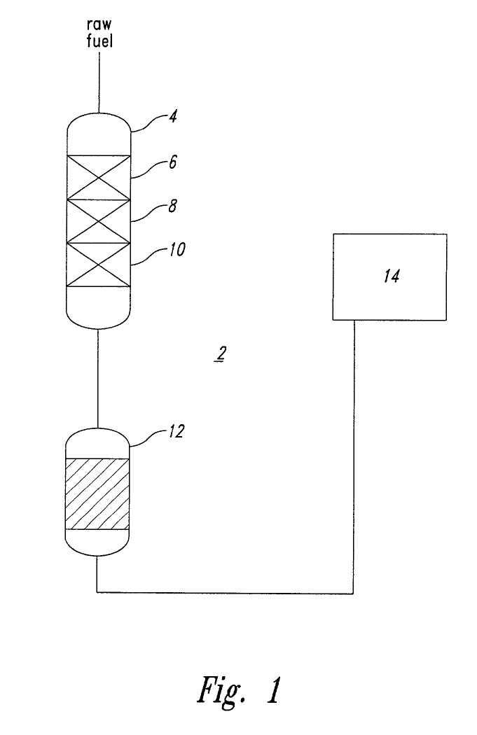

A fuel cell electric power generation system comprising the present desulfurization unit is also provided. FIG. 1 is a schematic representation of an embodiment of the present power generation system. In the power generation system 2, raw fuel, such as natural gas, is fed into vessel 4 and bed 6. Bed 6 comprises pelletized zinc oxide, which adsorbs a significant portion of the sulfur compounds in the fuel stream. In tests, the applicants have determined that the zinc oxide bed preferentially adsorbs primary sulfur compounds, in particular, H₂S, COS, and low molecular weight mercaptans, but also adsorbs some secondary sulfur compounds, such as propyl sulfide.

The fuel stream is then directed to bed 8, which comprises a supported nickel metal adsorbent. Nickel adsorbent bed 8 adsorbs a substantial amount of the remaining sulfur compounds in the fuel stream, and is particularly capable of adsorbing secondary sulfur compounds that pass through zinc oxide bed 6, such as dimethyl sulfide and tetrahydrothiophene, for example.

The fuel stream exiting nickel adsorbent bed 8 is then directed to guard bed 10, which comprises a copper-zinc adsorbent. In this embodiment, guard bed 10 adsorbs primary and secondary sulfur compounds that break through beds 6 and 8. The sulfur concentration of the fuel stream exiting vessel 2 is typically ≦1 ppm. Indeed, in tests using natural gas, the present desulfurizer was routinely able to reduce the sulfur concentration to less than 0.03 ppm.

The desulfurized fuel stream is then directed to fuel processor 12, where it is converted to a reformate stream comprising hydrogen. Fuel processor 12 may comprise a steam reformer or an autothermal reformer. Fuel processor 12 may also further comprise other fuel processing equipment, such as shift reactors and/or selective oxidizers. The selection of fuel processor components is not essential to the present power generation system and persons skilled in the art may choose fuel processing components suitable for a particular fuel and/or fuel cell configuration.

In addition, the fuel processing system may also comprise further components upstream of the desulfurization unit. For example, a heating unit may be situated upstream for heating the raw fuel stream before it enters the desulfurization unit. If the raw fuel contains oxygen, such as peak shave gas, for example, a pre-oxidizer may be present upstream of the desulfurization unit. Other components, such as compressors or heat exchange elements, for example, that are necessary or desirable for operation of system 2 are also not shown, but will be understood by persons skilled in the art to be present.

The reformate stream from fuel processor 12 is directed to fuel cell stack 14. Stack 14 converts the hydrogen stream and oxygen (supply not shown) to electricity that can be supplied to an electrical load.

The present desulfurization unit may be operated at a suitable operating temperature range, which will be determined, in part, by the selection of adsorbent beds. For example, a nickel metal adsorbent bed has a recommended operating temperature range of about 150° C. to about 300-400° C. Zinc oxide beds may operate at temperatures as high as about 750° C., whereas activated carbon beds function poorly at elevated temperatures. Of course, each of the beds of the present desulfurization unit may be maintained within different operating temperature ranges, if desired.

The present desulfurization unit may be brought to a suitable operating temperature range by conventional means. For example, the desulfurization unit may further comprise an upstream heating unit for heating the incoming fuel stream, electric heating elements for heating at least one of the adsorbent beds, or heat exchange elements associated with the beds, and any combination of such means. Heat exchange elements, in particular, could be used to heat the bed(s) during start-up, by flowing a heated fluid therethrough, for example, and also to maintain the beds within suitable temperature ranges during operation, particularly where each of the beds have different operating temperature ranges. Other temperature control means will be apparent to persons skilled in the art.

It is known that sulfur compounds, except H₂S, dissociate at higher temperatures and form H₂S. Table 1 shows the thermal decomposition temperatures of some representative primary sulfur compounds found in hydrocarbon fuels.

TABLE 1

| Sulfur Compound | Thermal Decomposition Temperature |
|---|---|
| n-butyl mercaptan | 150° C. |
| Isopropyl mercaptan | 225° C.-250° C. |
| Cyclohexyl mercaptan | 200° C. |
| Thiophenol | 200° C. |

A process of operating the present desulfurization unit is provided. In one embodiment, the present process comprises:

heating a hydrocarbon fuel stream comprising primary sulfur compounds to at least the thermal decomposition temperature of a portion of the primary sulfur compounds;

directing the fuel stream to the first adsorbent bed;

directing the heated fuel stream to the second adsorbent bed; and

directing the heated fuel stream to the third bed.

The fuel stream may be heated in an upstream heating unit, or in the first adsorbent bed, or both, if desired.

For example, the fuel stream could be heated to at least 150° C., the thermal decomposition temperature of n-butyl mercaptan, which will result in the sulfur compound dissociating to form H₂S. If the fuel stream is heated to at least 200° C., other primary sulfur compounds, such as cyclohexyl mercaptan and thiophenol will also dissociate to form H₂S. Heating the fuel stream to at least 250° C. will result in the majority of mercaptans dissociating to form H₂S.

Where the adsorbent in the first bed preferentially adsorbs H₂S, such as zinc oxide, for example, heating the fuel stream in this manner will increase the amount of H₂S and allow the first bed to more readily remove more of the sulfur compounds from the fuel stream.

The arrangement of the second and third adsorbent beds can be selected to advantage, depending on the choice of adsorbents for each of the beds, and on the nature and concentration of primary and/or secondary sulfur compounds in the hydrocarbon fuel stream to be desulfurized. Other factors to be considered include the cost and sulfur capacity of an adsorbent, as well as the intended operating temperatures of the beds.

For example, the embodiment of the present desulfurization unit illustrated in FIG. 1 is suitable for hydrocarbon fuels containing a greater proportion of primary sulfur compounds. If the raw fuel entering bed 6 is heated to at least 260° C., then most of the mercaptans present in the fuel will dissociate to form H₂S. The zinc oxide adsorbent will adsorb most of the H₂S and COS present in the fuel stream. Indeed, in tests using natural gas with 10 ppm sulfur, the zinc oxide bed typically adsorbs 80-90% of the sulfur.

However, the applicant has determined that at such temperatures, dimethyl sulfide can be produced in the zinc oxide bed: with natural gas at 260° C., the concentration of dimethyl sulfide exiting the bed is triple the concentration entering the bed. Without being bound by theory, it is possible that other sulfur compounds present in the fuel stream decompose to form smaller molecules that react to form dimethyl sulfide, or that methane in the natural gas stream reacts with some sulfur compounds on the adsorbent surface to form dimethyl sulfide.

The nickel adsorbent bed 8 adsorbs the dimethyl sulfide and other secondary sulfur compounds in the fuel stream. It is thought that the ability of the nickel adsorbent bed to adsorb these compounds is enhanced because of the reduction in concentration of primary sulfur compounds in the fuel stream.

The guard bed 10 then removes primary or secondary sulfur compounds remaining in the fuel stream so that the concentration of sulfur in the desulfurized fuel stream is ≦1 ppm, and can be less than 0.03 ppm.

Alternatively, the third bed may precede the second bed in the present desulfurization unit, if desired, and this arrangement may be suitable for hydrocarbon fuels having a greater proportion of secondary sulfur compounds. Examples of such fuels include gasoline and diesel, which typically contain higher concentrations of sulfides and disulfides, and thiophenes such as alkyldibenzothiophene (DBT), as compared to lighter hydrocarbon fuels. Further examples include pipeline natural gas or propane having significant concentrations of odorants such as dimethyl sulfide or tetrahydrothiophene.

For example, in the embodiment illustrated in FIG. 1, guard bed 10 could be placed upstream of nickel adsorbent bed 8. In this arrangement, the copper-zinc adsorbent in guard bed 10 would adsorb the major portion of primary and secondary sulfur compounds in the fuel stream received from first bed 6, and nickel adsorbent bed 8 would then remove a substantial portion of any secondary sulfur compounds left in the fuel stream.

This arrangement has advantages. First, the copper-zinc adsorbent is typically less expensive than the nickel adsorbent. Being upstream of the nickel adsorbent, the copper-zinc adsorbent will be spent first, instead of the nickel adsorbent. This results in a considerable cost saving in situations where a relatively large amount of secondary sulfur compounds are to be removed from the hydrocarbon fuel stream. Second, the copper-zinc adsorbent has a greater sulfur capacity than the nickel adsorbent, at comparable temperatures, and is thus able to remove more sulfur from the fuel before being spent.

In the present desulfurization unit, the third bed may be selected to have a minimum operating temperature that is lower than the respective minimum operating temperatures of the first and second beds. For example, in the embodiment of FIG. 1, the copper-zinc adsorbent of guard bed 10 has a minimum operating temperature of about 5° C., whereas the zinc oxide and nickel adsorbent beds have typical minimum operating temperatures in the range of about 150° C. to about 300° C.

During start-up, the guard bed is able to remove the sulfur compounds from the fuel stream at lower temperatures relative to the other beds. This may allow faster start up of the fuel processing system because it is not necessary to wait until the other beds have reached a minimum operating temperature and desulfurized fuel can be fed to downstream components sooner than would otherwise be possible. For example, at start-up the fuel and desulfurization unit could be at 20° C., and the minimum operating temperature of the first and second beds may be 260° C. If the guard bed has a minimum operating temperature of 20° C. or less, the fuel stream can be desulfurized in the guard bed while the other beds reach their minimum operating temperatures. In some applications, such as fuel cell electric power generation systems having a relatively short duty cycle, this can be an advantage as it may permit the power generation system to come online more quickly after start-up.

Once the other beds have reached suitable minimum operating temperatures, the guard bed can then resume its role in preventing break through of sulfur compounds to downstream components.

The present desulfurization unit and fuel cell electric power generation system provide several advantages. First, the present desulfurization unit permits desulfurization of hydrocarbon fuels having significant sulfur content (e.g., ≧10 ppm), including primary and secondary sulfur compounds, without the need for an HDS and associated hydrogen recycle. This significantly decreases the complexity of the fuel processing system, by eliminating the equipment, piping and control systems associated with the recycle.

At the same time, the present fuel cell electric power generation system can be started more quickly compared to current systems, since the guard bed in the present desulfurization unit can desulfurize the fuel while the other beds are heating up.

Further, the present desulfurization unit can be configured to cost-effectively desulfurize fuels based on the amount and nature of sulfur compounds present in the fuel. By contacting the fuel with a series of beds having decreasing sulfur capacities, efficient use can be made of the upstream bed(s). Where the beds are also arranged in decreasing cost of adsorbent, the cost of desulfurizing the fuel is also reduced. The design flexibility of the present desulfurization unit allows it to be adapted to a variety of fuels and end-use applications.

While particular elements, embodiments and applications of the present invention have been shown and described, it will be understood, of course, that the invention is not limited thereto since modifications may be made by those skilled in the art, particularly in light of the foregoing teachings. It is therefore contemplated by the appended claims to cover such modifications that incorporate those features coming within the scope of the invention.

What is claimed is:

1. A desulfurization unit comprising:
(a) a first adsorbent bed having an inlet for receiving a hydrocarbon fuel stream and comprising an adsorbent selected from the group consisting of metal oxides and zeolites;
(b) a nickel adsorbent bed downstream of the first bed; and
(c) a guard bed downstream of the first bed and comprising an adsorbent selected from the group consisting of copper-zinc adsorbents, activated alumina, activated carbon, and zeolites.

2. The desulfurization unit of claim 1 wherein the guard bed is downstream of the nickel adsorbent bed.

3. The desulfurization unit of claim 1 wherein the first bed comprises a metal oxide.

4. The desulfurization unit of claim 1 wherein the first bed comprises zinc oxide.

5. The desulfurization unit of claim 1 wherein the nickel adsorbent bed comprises nickel metal.

6. The desulfurization unit of claim 1 wherein the guard bed comprises a copper-zinc adsorbent.

7. The desulfurization unit of claim 1, further comprising a second adsorbent bed fluidly connected to the first bed, the second bed comprising an adsorbent selected from the group consisting of metal oxides and zeolites.

8. The desulfurization unit of claim 7 wherein the desulfurization unit is configured to allow one of the first and second beds to be disconnected during operation of the desulfurization unit while the other of the first and second beds remains in service.

9. The desulfurization unit of claim 8 wherein the first and second beds are fluidly connected in series.

10. The desulfurization unit of claim 8 wherein the first and second beds are fluidly connected in parallel and the desulfurization unit is configured to selectively direct the fuel stream through one of the first and second beds.

11. The desulfurization unit of claim 1, further comprising first and second nickel adsorbent beds downstream of the first bed.

12. The desulfurization unit of claim 11 wherein the desulfurization unit is configured to allow one of the first and second nickel adsorbent beds to be disconnected during operation of the desulfurization unit while the other of the first and second nickel adsorbent beds remains in service.

13. The desulfurization unit of claim 12 wherein the first and second nickel adsorbent beds are fluidly connected in series.

14. The desulfurization unit of claim 12 wherein the first and second nickel adsorbent beds are fluidly connected in parallel and the desulfurization unit is configured to selectively direct the fuel stream through one of the first and second nickel adsorbent beds.

15. The desulfurization unit of claim 1, further comprising first and second guard beds fluidly downstream of the first bed.

16. The desulfurization unit of claim 15 wherein the desulfurization unit is configured to allow one of the first and second guard beds to be disconnected during operation of the desulfurization unit while the other of the first and second guard beds remains in service.

17. The desulfurization unit of claim 16 wherein the first and second guard beds are fluidly connected in series.

18. The desulfurization unit of claim 16 wherein the first and second guard beds are fluidly connected in parallel and the desulfurization unit is configured to selectively direct the fuel stream through one of the first and second guard beds.

19. The desulfurization unit of claim 1, further comprising a heating element for heating the fuel stream and a fuel supply for directing the heated fuel stream to the first bed.

20. The desulfurization unit of claim 1, further comprising heating means for heating at least one of the first bed, nickel adsorbent bed and guard bed.

21. A desulfurization unit comprising:
(a) a vessel having an inlet and outlet for receiving and discharging a hydrocarbon fuel stream;
(b) a first bed disposed in an upstream portion of the vessel, the first bed comprising an adsorbent selected from the group consisting of metal oxides and zeolites;
(c) a second bed disposed in a downstream portion of the vessel, the second bed comprising a nickel adsorbent; and
(d) a guard bed disposed in a downstream portion of the vessel, the guard bed comprising an adsorbent selected from the group consisting of copper-zinc adsorbents, activated alumina, activated carbon, and zeolites.

22. The desulfurization unit of claim 21 wherein the second bed is upstream of the guard bed.

23. The desulfurization unit of claim 21 wherein the first bed comprises zinc oxide.

24. The desulfurization unit of claim 21 wherein the second bed comprises nickel metal.

25. The desulfurization unit of claim 21 wherein the guard bed comprises a copper-zinc adsorbent.

26. The desulfurization unit of claim 21, further comprising heating means for heating at least one of the first, second and guard beds.

27. The desulfurization unit of claim 26 wherein the heating means comprises an electric heating element associated with at least one of the first, second and guard beds.

28. The desulfurization unit of claim 26 wherein the heating means comprises heat exchange elements associated with the vessel.

29. The desulfurization unit of claim 21, further comprising heat exchange elements associated with the vessel for maintaining at least one of the first, second and guard beds within an operating temperature range.

30. A desulfurization unit comprising:
(a) a first bed for adsorbing primary sulfur compounds from a hydrocarbon fuel stream;
(b) a second bed for adsorbing secondary sulfur compounds from the fuel stream; and
(c) a guard bed for adsorbing primary and secondary sulfur compounds from the fuel stream,
wherein the first bed is upstream of the second bed and the guard bed.

31. The desulfurization unit of claim 30 wherein the second bed is upstream of the guard bed.

32. The desulfurization unit of claim 30 wherein the first bed comprises an adsorbent selected from the group consisting of metal oxides and zeolites.

33. The desulfurization unit of claim 30 wherein the first bed comprises zinc oxide.

34. The desulfurization unit of claim 30 wherein the second bed comprises a nickel adsorbent.

35. The desulfurization unit of claim 30 wherein the guard bed comprises an adsorbent selected from the group consisting of copper-zinc adsorbents, activated alumina, activated carbon, and zeolites.

36. The desulfurization unit of claim 30 wherein the guard bed comprises a copper-zinc adsorbent.

37. The desulfurization unit of claim 30, further comprising a heating unit upstream of the first bed for heating the fuel stream.

38. The desulfurization unit of claim 30, further comprising a heat exchange element associated with at least the first bed.

39. A process for reducing the sulfur content of a hydrocarbon fuel stream comprising primary sulfur compounds to ≦1 ppm, the process comprising:
(a) heating the fuel stream to a temperature greater than or equal to the thermal decomposition temperature of at least a portion of the primary sulfur compounds;
(b) directing the fuel stream to a first bed comprising an adsorbent selected from the group consisting of metal oxides and zeolites;
(c) directing the heated fuel stream to a nickel adsorbent bed downstream of the first bed; and
(d) directing the heated fuel stream to a guard bed downstream of the second bed, the guard bed comprising an adsorbent selected from the group consisting of copper-zinc adsorbents, activated alumina, activated carbon, and zeolites.

40. The process of claim 39 wherein the fuel stream is heated before being directed to the first bed.

41. The process of claim 39 wherein the fuel stream is heated within the first bed.

42. The process of claim 39 wherein the fuel stream is heated to at least 150° C.

43. The process of claim 39 wherein the fuel stream is heated to at least 200° C.

44. The process of claim 39 wherein the fuel stream is heated to at least 225° C.

45. The process of claim 39 wherein the fuel stream is heated to at least 250° C.

46. The process of claim 39 wherein the first bed comprises a metal oxide.

47. The process of claim 39 wherein the first bed comprises zinc oxide, the guard bed comprises a copper-zinc adsorbent, and the first bed, nickel adsorbent bed and the guard bed are maintained at an operating temperature within the range of about 150° C. to about 750° C.

48. The process of claim 47 wherein the operating temperature is within the range of about 150° C. to about 400° C.

49. The process of claim 47 wherein the operating temperature is greater than about 250° C.

50. The process of claim 47 wherein the operating temperature is within the range of about 260° C. and about 400° C.

51. A process for reducing the sulfur content of a hydrocarbon fuel stream comprising secondary sulfur compounds to ≦1 ppm, the process comprising:
(a) directing the fuel stream to a first bed comprising an adsorbent selected from the group consisting of metal oxides and zeolites;
(b) directing the fuel stream to a guard bed downstream of the first bed, the guard bed comprising an adsorbent selected from the group consisting of copper-zinc adsorbents, activated alumina, activated carbon, and zeolites; and
(c) directing the fuel stream to a third bed downstream of the guard bed, the third bed comprising a nickel adsorbent.

52. The process of claim 51 wherein the fuel stream in the first bed is at a temperature of at least 150° C.

53. The process of claim 51 wherein the fuel stream in the first bed is at a temperature of at least 200° C.

54. The process of claim 51 wherein the fuel stream in the first bed is at a temperature of at least 250° C.

55. The process of claim 51 wherein the first bed comprises zinc oxide, the guard bed comprises a copper-zinc adsorbent, and the third bed comprises nickel metal.

56. A fuel cell electric power generation system comprising:
(a) a fuel processing system for converting a hydrocarbon fuel stream to a reformate stream comprising hydrogen, the fuel processing system comprising a desulfurization unit comprising:
(i) a metal oxide adsorbent bed;
(ii) a nickel metal adsorbent bed downstream of the metal oxide bed; and
(iii) a copper-zinc guard bed downstream of the metal oxide bed; and
(b) a fuel cell stack for receiving the reformate and connectable to an electrical load.

57. The power generation system of claim 56, further comprising a vessel having an inlet and outlet for receiving and discharging the fuel stream, wherein the metal oxide adsorbent bed, nickel metal adsorbent bed and the guard bed are disposed in the vessel.

58. The power generation system of claim 56 wherein the metal oxide adsorbent bed comprises zinc oxide.

59. The power generation system of claim 56, further comprising a heating unit located upstream of the metal oxide adsorbent bed for heating the fuel stream.

60. The power generation system of claim 56, further comprising heating means for heating the metal oxide adsorbent bed.

61. The power generation system of claim 56 wherein the fuel processing system further comprises a pre-oxidizer located upstream of the desulfurization unit.

62. The power generation system of claim 56 wherein the fuel processing system further comprises a steam reformer located downstream of the desulfurization unit.

63. The power generation system of claim 56 wherein the fuel processing system further comprises an autothermal reformer located downstream of the desulfurization unit.

64. A method of operating a fuel cell electric power generation system comprising
a fuel processing system for converting a hydrocarbon fuel stream to a reformate stream comprising hydrogen, the fuel processing system comprising a desulfurization unit, the desulfurization unit comprising
a metal oxide adsorbent bed,
a nickel metal adsorbent bed downstream of the metal oxide bed, and
a copper-zinc guard bed downstream of the metal oxide bed, and
a fuel cell stack for receiving the reformate and connectable to an electrical load, the method comprising:
(a) directing the fuel stream to a first bed comprising an adsorbent selected from the group consisting of metal oxides and zeolites, and having a first minimum operating temperature;
(b) directing the fuel stream to a downstream second bed comprising a nickel adsorbent, and having a second minimum operating temperature;
(c) directing the fuel stream to a downstream guard bed comprising an adsorbent selected from the group consisting of copper-zinc adsorbents, activated alumina, activated carbon, and zeolites, and having a third minimum operating temperature lower than the first and second minimum operating temperatures; and
(d) heating the fuel stream to a process temperature that is higher than or equal to any of the first, second and third minimum operating temperatures.

65. The method of claim 64 wherein, during a first period, the fuel stream is at an initial temperature at or above the third minimum operating temperature and below at least one of the first and second minimum operating temperatures.

66. The method of claim 65 wherein the third operating temperature is about 20° C.

67. The method of claim 66 wherein the initial temperature is less than about 150° C.

68. The method of claim 64 wherein the process temperature is at least about 260° C.

69. The method of claim 64 wherein the first minimum operating temperature is about 150° C.

70. The method of claim 64 wherein the first minimum operating temperature is about 260° C.

71. The method of claim 64 wherein the second minimum operating temperature is about 150° C.

72. The method of claim 64 wherein the second minimum operating temperature is about 260° C.

73. The method of claim 64 wherein step (d) precedes step (a).

74. The method of claim 64 wherein step (a) and step (d) occur simultaneously.

75. The method of claim 64 wherein step (b) precedes step (c).
